(19) United States
(12) Patent Application Publication
(10) Pub. No.: US 2009/0271358 A1
(43) Pub. Date: Oct. 29, 2009

(54) Evidential Reasoning Network and Method

(76) Inventors: Eric Lindahl, Crofton, MD (US); Plamen V. Petrov, Omaha, NE (US); Brett P. Walenz, Omaha, NE (US)

Correspondence Address: ARNOLD & PORTER LLP;ATTN: IP DOCKETING DEPT., 555 TWELFTH STREET, N.W., WASHINGTON, DC, 20004-1206, US

(21) Appl. No.: 12/431,751

(22) Filed: Apr. 28, 2009

Related U.S. Application Data
(60) Provisional application No. 61/048,277, filed on Apr. 28, 2008.

(51) Int. Cl. G06N 5/02; G06Q 99/00; G06N 7/06

(52) U.S. Cl. 706/51; 705/1; 706/46; 706/52

(57) ABSTRACT

The present invention relates generally to expert systems that synthesize data from multiple disparate sources of evidential information. More specifically, the present invention relates to systems, methods, devices, and computer readable media for implementing evidential reasoning with multi-agent systems.

### CROSS-REFERENCE TO RELATED APPLICATIONS

This application claims the benefit under 35 U.S.C. § 119(e) of U.S. Provisional Application No. 61/048,277, filed Apr. 28, 2008, the entirety of which is incorporated herein by reference.

### FIELD OF THE INVENTION

The present invention relates generally to expert systems that synthesize data from multiple disparate sources of evidential information. More specifically, the present invention relates to systems, methods, devices, and computer readable media for implementing evidential reasoning with multi-agent systems.

### BACKGROUND OF THE INVENTION

With the advent of widespread data sharing systems, the level of access to various sources of information has greatly increased. As the amount of data available for analysis grows, the intelligence community needs an effective tool to correlate and integrate information from multiple disparate sources. An intelligence analyst reviews information from many sources, such as field reports from operatives (i.e., “Human Intelligence” or “HUMINT”), technical reports from sensors (e.g., communication signals, photographs, and measurements from instruments), and so-called “open sources” (e.g., newspapers, magazines, books, and the Internet). Although it is a rich repository of information, the Internet is limited as a data source by uncertainty surrounding the provenance and reliability of its content.

An effective information analysis system must draw conclusions by analyzing thousands of intelligence leads gathered from various information resources, then determining whether the gathered intelligence leads have real world implications or if they are not valid sources of intelligence. All of these tasks must be performed in a complex information space consisting of a large parameter set representing various criteria, constraints, and alternatives. The intelligence analysis system must be able to handle very large sets of data and respond well to a variety of faults and inconsistencies (e.g., hardware or software failures, network failures, and data uncertainty or unavailability) while providing the best results possible in an efficient and timely process.

Several applications are used in the intelligence analysis community to analyze leads gathered from various information channels, but these systems do not track the decision-making process and do not provide an aggregate function to represent the entire state of the underlying progress toward a particular hypothesis. For example, CrimeLink™, a popular data visualization software product that transforms information into different visual representations viewable by the user, does not provide a means to track the decision and reporting processes an analyst performs when systematically analyzing evidence. In a similar fashion, Analyst's Notebook® by i2, Inc. provides a data visualization and analysis toolkit used by some intelligence analysts to form their opinions, but it does not provide an explicit transactional tracking and reporting mechanism for these opinions. The present invention improves on these and other automated information analysis systems by providing users with the ability to represent, track, and combine opinions in a collaborative environment with multiple users.

### BRIEF SUMMARY OF THE INVENTION

The present invention discloses systems, methods, devices, and computer readable media for implementing evidential reasoning with multi-agent systems.

The present invention includes an evidential reasoning system comprising a root fuse node; at least one decision agent having a subordinate fuse node; and one or more evidence items; wherein said at least one decision agent renders at least one direct opinion on said one or more evidence items; and wherein said root fuse node is coupled to said subordinate fuse node through a trust discount node.

### BRIEF DESCRIPTION OF THE DRAWINGS

FIG. 1 depicts a simplified intelligence analysis scenario.

FIG. 2 depicts a simplified evidential reasoning network according to an embodiment of the invention.

FIG. 3 depicts a relationship between an opinion consumer and an opinion source according to an embodiment of the invention.

FIG. 4 depicts components of the evidential reasoning network according to an embodiment of the invention.

FIG. 5 depicts a relationship between direct opinions, indirect opinions and a decision agent network according to an embodiment of the invention.

FIG. 6 illustrates steps involved in querying the evidential reasoning network according to an embodiment of the invention.

FIG. 7 depicts an evidential reasoning network implemented in a distributed fashion.

FIG. 8 depicts an embodiment of the invention that can be used in intelligence analysis and other fields.

FIG. 9 illustrates steps that may be involved in calculating a consensus value according to an embodiment of the invention.

FIG. 10 illustrates steps that may be involved in adding opinions to the evidential reasoning network according to an embodiment of the invention.

FIG. 11 depicts an embodiment of the invention that can be used for performing information fusion and federated search.

FIG. 12 depicts an embodiment of the invention that can be used for performing a simple federated search.

### DETAILED DESCRIPTION OF THE INVENTION

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention.

The inherent uncertainties embedded in traditional intelligence operations hamper effective intelligence analysis. These inherent uncertainties include the imprecision surrounding the sensing and collection of intelligence inputs, the unpredictability of a monitored subject's intentions and actions, the inadequacy of reasoning and decision models, and the dynamic effects of environmental settings. In most situations, the sets of information available for intelligence analysis are incomplete, imprecise, or inconsistent, and the decision space and its parameter sets cannot be defined without some level of ambiguity.

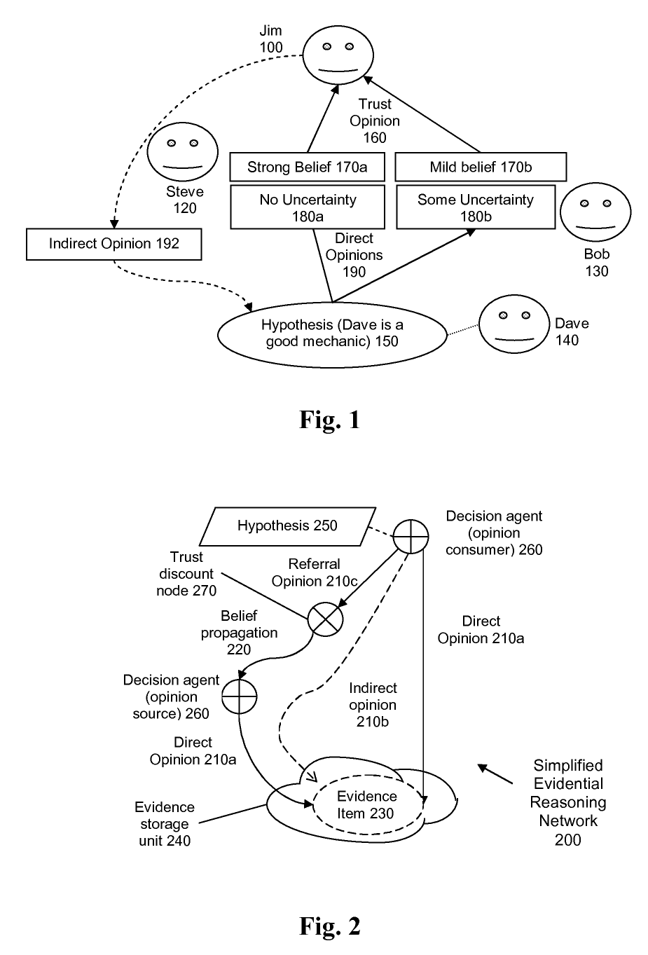

FIG. 1 depicts a simplified intelligence analysis scenario involving uncertainty. Jim 100 needs to find a good mechanic to repair his car, but he does not have personal experience with one. He asks two friends, Steve 120 and Bob 130, for recommendations. They both recommend the same mechanic, Dave 140. Steve 120 recommends Dave 140 strongly because he has strong belief 170a and no uncertainty 180a that Dave 140 is a good mechanic, while Bob 130 has a mild belief 170b and some uncertainty 180b about Dave's skill as a mechanic. Assuming that Jim 100 has some level of trust (a trust opinion 160) in Steve and Bob's direct opinions 190, Jim 100 has now formed an indirect opinion 192 on Dave's ability as a mechanic based on the direct opinions 190 of his friends.

In this scenario, Jim 100 acts as a very simple information analysis system, synthesizing multiple sources of information into an overall opinion and managing the uncertainty in the data. Jim 100 originally had no opinion on the hypothesis 150 that “Dave is a good mechanic.” Through the process of soliciting direct opinions 190, and applying his trust opinion 160 to the sources of the opinions (i.e., Steve 120 and Bob 130), Jim 100 was able to form an indirect opinion 192 on the hypothesis 150. Both Steve 120 and Bob 130, on the other hand, had direct opinions 190, based on evidence, that Dave 140 is a good mechanic. However, Bob 130 had some uncertainty 180b about the hypothesis 150. Based on the trust opinion 160 that Jim 100 placed in the direct opinions 190 of both Steve 120 and Bob 130, his newly formed indirect opinion 192 should reflect some of that uncertainty 180b. That is, the beliefs (170a and 170b) and uncertainties (180a and 180b) have propagated through the trust network depicted in FIG. 1.

### DEFINITIONS

Throughout the specification and claims, the following definitions apply:
Analyst—A human decision agent who is capable of rendering opinions about evidence with respect to a hypothesis.
Belief—A tuple consisting of (belief, disbelief, and uncertainty) probabilistic values.
Characterizer—A software decision agent that is capable of rendering opinions about evidence with respect to a hypothesis.
Consensus—A value resulting when two or more opinions are merged together according to a belief calculus rule (or an operator).
Decision Agent—Any entity (whether human or software-based) capable of rendering opinions about evidence with respect to a hypothesis, i.e., a general term that includes both analysts and characterizers
Discount Node—A node in the evidential reasoning network that represents the trust opinion of one decision agent (opinion consumer) for another agent's (opinion source) opinions; discount nodes are used in the trust discounting of the source agent's opinions before they can be used by the opinion consumer agent.
Evidence Item—An arbitrary informational item that represents some facet of the real world, which can be captured in a computer or on computer-based media, such as a measurement, an observation, a description of a person, place, or event, a news item, and so forth. Decision agents evaluate evidence against a particular hypothesis and state opinions (representing their belief) about the contribution of an evidence item to a hypothesis.
Fact—An item of evidence that represents a factual statement about the real world. The fact is evaluated as evidence pertaining to a particular hypothesis by decision agents.
Functional Opinion—An opinion expressed by a decision agent about an evidence item expressing the decision agent's belief and uncertainty about the contribution of the evidence to a particular hypothesis.
Fuse Node—A node in the evidential reasoning network, associated with a decision agent, where the corresponding decision agent performs consensus operations of multiple opinions (direct or indirect) to derive one fused opinion regarding a particular hypothesis. Also referred to as subordinate fuse node.
Hypothesis—An individual proposition or question in the topic domain about which opinions stating belief, disbelief, or uncertainty, can be expressed
Indirect Opinion—An opinion that a decision agent has formed about an item of evidence it has not examined directly, based only on one or more referral opinions.
Opinion—The representation of belief in a particular fact (evidence item) rendered by a particular decision agent or the representation of trust in the opinions of other decision agents.
Opinion Consumer—A decision agent that defines the level of trust it has in the opinions of another decision agent; the opinion consumer expresses trust in the opinions of another decision agent, the opinion source.
Opinion Object—A part of an opinion which represents the target about which the opinion is issued, including an evidence item or a decision agent. In the case where the opinion object is a decision agent, the opinion is also referred to as a trust opinion or a referral opinion. In the case where the opinion object is an evidence item, the opinion is a functional opinion.
Opinion Source—A decision agent, who issues opinions on evidence and whose opinions are received and may be evaluated by another decision agent, the opinion consumer. Also sometimes referred to as Opinion Object.
Opinion Subject—A decision agent who issues the opinion; sometimes referred to as Opinion Consumer.
Referral Opinion—An opinion a decision agent (opinion consumer) receives that is formed by applying a trust discount chain on the opinions of one or more other (subordinate) decision agents about a particular evidence item.
Topic Domain—A general subject on which all opinions are made (sometimes referred to as a “Frame”)
Transaction—An act of an opinion change, together with a record of the date, time, and other information related to the opinion change event.
Trust Discount—A mathematical modification of an original opinion from an opinion source based on the trust relationship between the opinion consumer and an opinion source.
Trust Opinion—An opinion about the relationship between an opinion consumer and an opinion source, where the level of trust in the opinion source is expressed by the opinion consumer through the (belief, disbelief, uncertainty) tuple in the opinion.
Uncertainty—A member of the belief tuple that represents the ambiguity in an opinion; the amount of uncertainty may represent either belief or disbelief, depending on factors unknown to the decision agents at a particular moment.

The evidential reasoning network of the present invention provides the ability to represent a decision-making environment as an interconnected network of evidence items, direct opinions, indirect opinions, and referral opinions. FIG. 2 depicts a simplified version of an evidential reasoning network 200 according to one embodiment of the invention. As shown in FIG. 2, decision agents 260 form direct opinions 210a and indirect opinions 210b on a hypothesis 250 (e.g., a textual proposition such as “Team X will win the Super Bowl.”), taking into account a collection of evidence items 230 (i.e., data items supportive or not supportive of the hypothesis 250), which are stored together in an evidence storage unit 240. Decision agents 260 are capable of rendering direct opinions 210a on evidence 230 with respect to a hypothesis 250 and expressing trust in the direct opinions 210a of one or more other decision agents 260 with respect to a hypothesis 250.

Opinions may be direct opinions 210a, indirect opinions 210b, or referral opinions 210c [collectively referred to as “opinions 210”]. Direct opinions 210a are made directly on evidence items 230. As explained below, indirect opinions 210b are the result of applying a trust discount to a direct opinion 210a of a decision agent 260a at trust discount node 270. The trust discount is determined by a referral opinion 210c, which is a measure of the trust one decision agent 260 (the opinion consumer) has in the direct opinions 210a of another decision agent 260 (the opinion source).

The decision agent 260 can be an analyst (a human being), a characterizer (a software decision agent), or both. A characterizer is an intelligent automation, such as an algorithm or a computer program, capable of producing opinions 210 on evidence items 230 within a topic domain. Direct opinions 210a and indirect opinions 210b can then be propagated through the system 200 to a produce a final outcome, or a consensus with respect to a particular decision agent 260, which captures that decision agent 260's belief regarding the hypothesis 250 given the evidence items 230 in the system 250. Additionally, the evidential reasoning network 200 is transaction-aware, meaning that evidence items 230 and opinion change-events are recorded in a timeline. Likewise, changes in opinions expressed by decision agents 260 over time, either expressing different levels of belief in one or more evidence items 230, or expressing different levels of trust in other agents' direct opinions 210a, are recorded by transaction logic in the system.

An opinion 210 is the representation of a decision agent's belief in a particular evidence item 230 or that decision agent's trust in the opinion 210 of another decision agent 260. An opinion 210 is represented by the tuple (Belief, Disbelief, Uncertainty) where each of the three values of Belief (B), Disbelief (D), or Uncertainty (U) are expressed on a probabilistic scale (0 to 1), where B+D+U=1. Because a third value can always be calculated from two known values, an opinion 210 can also be expressed as a tuple with two of the three values B, D, or U. Opinions 210 are used as a representation for facts that may be less than certain or that contain ambiguity. Opinions operate in a framework containing at least the following elements: topic domain, decision agent, opinion object, and transaction. The opinion object can be either an evidence item 230 (functional opinion) or another decision agent 260 (trust opinion).

In the system of the present invention, a trust opinion 160 is defined as an opinion on the relationship between an opinion consumer 260 and an opinion source 260. The opinion consumer 260 defines the level of trust it has in the opinions of the opinion source 260 by expressing the Belief, Disbelief, and Uncertainty values (BDU values) for that opinion source 260. Trust opinions 160 may be defined with or without considering any particular hypothesis; if no hypothesis is specified, the trust opinion 160 applies to all opinions 210 from the opinion source 260 to the opinion consumer 260. Trust opinions 160 are used in trust discount chains, where the opinions of the opinion source 260 are discounted by the opinion consumer 260 with the BDU values of the trust opinion.

When two or more opinions 210 are merged together, the merged opinion is a consensus of the contributing opinions 210. As used herein, the consensus is an operator that takes one or more opinions 210, and by performing a mathematical transformation, defines a new opinion that represents the merger of all contributing opinions 210. Along with Belief and Disbelief, the consensus takes into account the Uncertainty expressed by each contributing opinion 210.

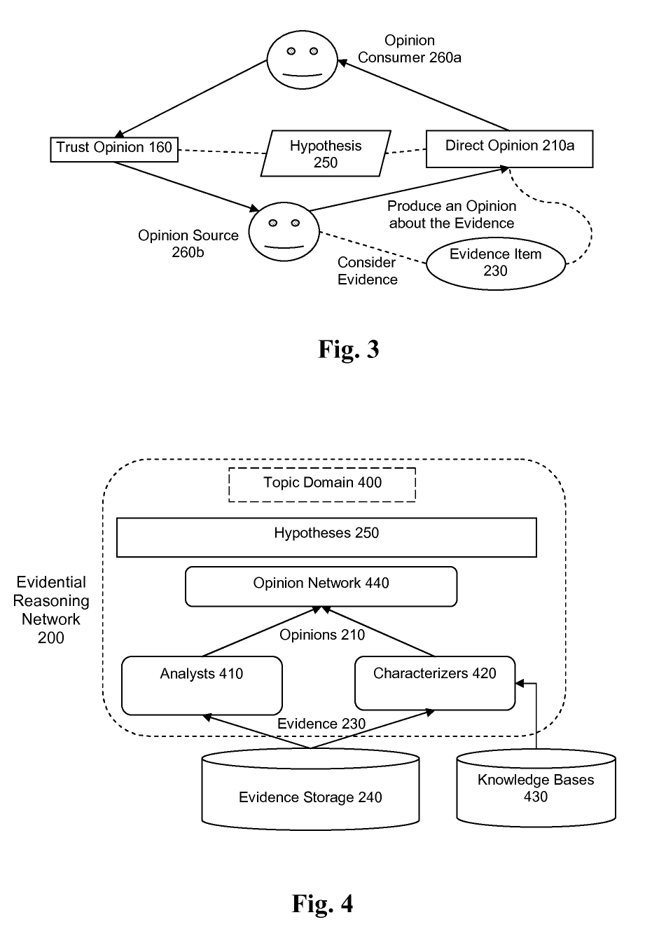

FIG. 3 depicts the relationship between an opinion consumer 260a and an opinion source 260b, where both are instances of decision agents 260. When an opinion consumer 260a utilizes direct opinions 210a from an opinion source 260b, the opinion consumer 260a applies a trust chain discount on those direct opinions 210a based on the inherent trust opinion 160 the opinion consumer 260a has in that opinion source 260b. The chain trust discount is a mathematical operator (e.g. subjective logic discount operator) that modifies the original belief value expressed in the direct opinion 210a of the opinion source 260b based on the trust opinion 160 that the consumer 260a has in the opinion source 260b. Unless the opinion consumer 260a has complete trust in the opinion source 260b (i.e., 100% belief and 0% uncertainty about the opinion source 260b), the discounted opinion will have a lower belief value than the direct opinion 210a of the opinion source 260b.

Opinions 210 are based on evidence items 230. An evidence item 230 can be a factual item, a rule, a document, a snippet of text, a video, or other forms of information. When an opinion is rendered on an evidence item 230, the evidence item 230 joins the topic domain and is considered a contributor to the resolution of the hypothesis 250 in question.

Evidential reasoning implies that the “facts” or evidence items 230 that a decision agent 260 may use as a basis for a judgment are not simple true/false propositions. The facts are likely the result of input from various sensors and human observers, filtered by various layers of mechanistic or human analysis. These facts are likely to contain degrees of uncertainty, whether from the accuracy of an observation or from the error rates inherent in the data processing and analysis algorithms.

In the system of the present invention, this uncertainty may be tracked and calculated using an approach known as probability calculus. There are several variants of probability calculus that can be applied, such as Bayesian theory. Probabilistic approaches are sound, meaning i.e. well defined for all values and consistent, when uncertainty is caused by factors, such as an algorithm's error rate, which can be sampled and measured to generate the necessary a priori data required for generating conditional probability tables to be used in Bayesian calculations. Other approaches for the belief calculus may be used in the present invention, such as Dempster-Shafer theory and Subjective Logic theory which are known to one of skill in the art. In a preferred embodiment, the Subjective Logic theory is used, which is further described below.

Dempster-Shafer Belief Theory

Taking the simple example of a coin flip, the Dempster-Shafer belief theory would prescribe values for the probability of heads, the probability of tails, and the probability of uncertainty. The uncertainty represents doubt about the probabilities themselves. For example, if a test subject X were shown a coin and asked what the chances would be of a particular result of a coin flip, X would not be able to say that the coin is fair, or what the chance is of it being fair; X would be wholly uncertain. If after testing, X was 80% confident that the coin was fair, X would have a 40% chance of heads, a 40% chance of tails, and still have 20% uncertainty.

The simple explanation above, while intuitive, is not completely representative of the full power of the Dempster-Shafer belief theory. The more precise representation is the concept of the power set of possibilities. The power set is the set of all possible combinations of the elements in the set. Starting with the set of Heads and Tails that are the results of a coin flip, the uncertainty in the coin flip can be represented with different probabilities:

m({ })=0, m({H})=0.4, m({T})=0.4, m({H,T})=0.2

The label “m” is used instead of the classic P because these are not quite the probabilities of receiving a heads, but rather, the probability mass that supports that specific part of the power set. This mass is referred to as the basic probability assignment, or bpa.

Other quantities associated with Dempster-Shafer are Belief and Plausibility. Belief is defined, per set A, as the sum of the bpas for all subsets of A. Plausibility is defined on similar sets as the sum bpas for all sets that have a non-zero intersection with A. For brevity, the Belief assigned to a set is abbreviated as Bel(S) and the Plausibility as Pl(S).

Continuing the coin flip example, Bel({T})=0.4, because the only non-empty subset of {T} is {T}. However, Bel({H,T}) is 1, because the guesser believes absolutely that a head or tail will occur. Pl({T}) is m({T})+m({H,T}), or 0.6. This represents the guesser's uncertainty in another way: it is plausible that the probability of tails is as high as 60%. Note that the difference between Bel({T}) and Pl({T}) is the uncertainty mentioned earlier.

Another important aspect of Dempster-Shafer is in the combination of evidence. This combination, or joint, can be computed using the following functions:

$${m}_{12} ( A ) = \frac{{\sum }_{B ⋂ C = A} {m}_{1} ( B ) {m}_{2} ( C )}{1 - K} when A = Ø$$

$$where K = {\sum }_{B ⋂ C = Ø} {m}_{1} ( B ) {m}_{2} ( C )$$

When A is the null set, the mass of the joint is 0. This combination has a strong intuitive nature, where the mass that agrees is divided by 1 minus the disagreement. This normalization factor on the bottom causes all disagreement to be swept away in that particular probability mass. This may not be the most desirable behavior in some cases, which is why a number of alternative combination rules have been devised. There are many different rules for the combination of evidence, and some of them can be interpreted as various forms of projection.

Subjective Logic

Subjective Logic is a mathematical model for representing uncertainty that builds upon the basic ideas presented by Dempster and Shafer to incorporate the subjectivity of all observations. In Subjective Logic, opinions (as opposed to facts) are the focus. An opinion ωₓ^{A} on a subject x by a party A (e.g., a decision agent) is a 3-tuple of the Belief (bₓ^{A}), Disbelief (dₓ^{A}), and Uncertainty (uₓ^{A}) about the subject x (e.g. a hypothesis). Note that bₓ^{A}+dₓ^{A}+uₓ^{A}=1, so while it is not necessary to specify all three of these values, it is convenient when performing certain calculations.

Subjective Logic introduces the consensus operator to combine opinions and the discount operator to support the belief in the source of an opinion. It has been shown that the consensus combination rule generates more intuitively correct results than common variants of Dempster's rule. Subjective Logic can be viewed as an extension to binary logic and probability calculus. The consensus between two opinions ωₓ^{A} and ωₓ^{B} is defined by the formulas in the figure below, where the result of the consensus operator (ωₓ^{A}⊕ωₓ^{B}) is defined in terms of the belief bₓ^{A,B}, disbelief dₓ^{A,B}, and uncertainty uₓ^{A,B} values that comprise the resultant tuple. If both opinions have no uncertainty, then K=0, and different forms of these equations, which are known to one of skill in the art, can be employed.

$$K = {u}_{x}^{A} + {u}_{x}^{B} - {u}_{x}^{a} {u}_{x}^{B}$$

$${b}_{x}^{A , B} = \frac{{b}_{x}^{A} {u}_{x}^{B} + {b}_{x}^{B} {u}_{x}^{A}}{K}$$

$${d}_{x}^{A , B} = \frac{{d}_{x}^{A} {u}_{x}^{B} + {d}_{x}^{B} {u}_{x}^{A}}{K}$$

$${u}_{x}^{A , B} = \frac{{u}_{x}^{A} {u}_{x}^{B}}{K}$$

### Subjective Logic Consensus Operator ⊕

As mentioned previously, the discount operator in Subjective Logic represents the action of modifying an original opinion by another opinion that represents the trust in the source of the original opinion. In the formulae below the opinion ω_{B}^{A} represents the trust opinion that the decision agent A (opinion consumer) has on another decision agent B (opinion source). This is a model for the concept of trust, where an opinion source (decision agent) that is trusted would have its opinions discounted only slightly, while another decision agent that is not trustworthy would have its opinions be discounted greatly. The equations below may be used to define the Subjective Logic discount operator in terms of the resultant tuple's Belief, Disbelief and Uncertainty values.

$${b}_{x}^{A , B} = {b}_{B}^{A} {b}_{x}^{B}$$

$${d}_{x}^{A , B} = {b}_{B}^{A} {d}_{x}^{B}$$

$${u}_{x}^{A , B} = {d}_{B}^{A} + {u}_{B}^{A} + {b}_{B}^{A} {u}_{x}^{B}$$

### Subjective Logic Discount Operator

The expressivity of the belief algebra is important in a heterogeneous system that may be incorporating some mixture of probabilistic and evidential reasoning. When working in known probability measure spaces, the belief algebra should reduce to probability calculus to preserve the accuracy and functionality of the supporting probabilistic systems. Subjective Logic easily meets this requirement.

A Distributed Evidential Reasoning System

The belief algebra implementation allows for integration and use of a wide range of multi-agent architectures. The system uses an extensible belief algebra library that simultaneously supports evidential and probabilistic reasoning. The system provides flexibility in adapting evidential reasoning by allowing integration of semi-consistent subject domains. Evidential reasoning systems may have scalability problems due to the exponential size of belief frames. Allowing less fit domains may result in smaller semantic label requirements, and thus tractable belief frames. By negotiating only the best fit concept labels, domains may be simplified to binary frames, thus removing the need to negotiate more complete belief frames.

Hypotheses that have a hidden or unknowable structure (such as those represented in the human mind or in partially revealed analysis systems) may have some conflicting representations. Designing software and algorithms is much easier with uniform representations, and often systems are predicated on the existence of such systems. However, in the real world, the hypothesis will likely have many representations in different knowledge systems and cultures. Being able to analyze these multiple competing hypothesis is an important capability for the modern user. The system's extensible belief algebra implementation provides for many levels of integration of analysis and can directly support Heuer's Analysis of Competing Hypotheses.

The decomposition of a hypothesis allows the network to be represented as a series of decisions, intelligence items, and collaboration points. For instance, users working on the same intelligence item can produce a consensus value for what they believe is the importance of the intelligence item. The evidential reasoning network acts as a semantically-tagged belief fusion layer for evidential management, allowing for disparate and novel pattern classification and fusion technology to be quickly and safely integrated while leaving the human in the loop.

The Evidential Reasoning Network (ERN) belief algebra architecture allows different belief algebras to be treated as drivers and loaded per domain. In particular, the belief algebra used may have different methods of handling scale and atomicity for possibly incomplete frames of discernment. ERN is meant to evolve with the science of uncertainty representation and management. As new methods are discovered, they can be adapted to the ERN uncertainty management methodology for integration into ever more precise epistemic uncertainty management.

In the system of the present invention analysts can adjust the reasoning mechanism at any time during the operation. The characterizer functionality and trust levels can be manually adjusted by analysts to balance lesser performing characterizers with better performing characterizers. Analysts can browse all of the current evidence items and render their opinions at any time, as well as modifying their trust in the different opinion sources.

The system explicitly manages trust in opinion sources that provide opinions according to topic domains. No opinion source has yet proven to be free of error in the general case, and setting trust explicitly allows direct involvement in the system by analysts. The system allows a given opinion source to be used in restricted domains, and the opinion source's output can be used in a gradation ranging between untrusted (where trust or distrust has not been determined), distrusted, and trusted. A common example of a distrusted opinion source is a characterizer working in an environment in which it does not perform at optimal levels. A specific example is an image processing characterizer operating on imagery that is known to have lots of sensor noise causing the characterizer to underperform. Similar performance issues with automated characterizers create the necessity for human topic domain experts (e.g. experts in a particular research area) to vet the results from automated intelligence analysis tools, as it may be critical that human experts verify the mechanistic results during critical decision-making processes. The present invention supports this use case by: 1) the ability of the system to represent and use both automated characterizer opinions and human expert opinions; and 2) tuning the trust in automated characterizers according to their particular area of expertise as compared to the current situation. This tuning of trust in the characterizers may happen either manually, by human agents specifying trust opinions, or semi-automatically, by the system applying certain quality rules.

The trust levels human experts have in different characterizers (and in other human agents, for that matter) may be difficult to map, encode, and keep current in a completely automated system. Therefore, in one embodiment of the present invention, a human interface is provided that allows analysts to augment the automated analysis system by manually manipulating the trust levels associated with specific characterizers and other subordinate analysts in a manner that would otherwise be prohibitively expensive to automate. This is accomplished by setting the trust opinions in the trust discount nodes that connect the analyst's fuse node to other decision agents' fuse nodes, whether those decision agents are automated characterizers or other analysts.

FIG. 4 represents the primary high-level components of the evidential reasoning network 200 of the present invention. Components of the evidential reasoning network 200 include a topic domain 400; one or more hypotheses 250; an opinion network 440 for each hypothesis 250; and a set of analysts 410 and characterizers 420 that may feed one or more opinion networks 440. The hypothesis 250 states a detailed question within the topic domain 400. The hypothesis 250 is associated with an opinion network 440, which is responsible for receiving and processing instances of evidence 230 and opinions 210. The evidential reasoning network 200 provides a representation of the relationships between the evidence 230 in the evidence storage 240, the analysts 410, characterizers 420, and the opinions 210.

The evidential reasoning network 200 is capable of propagating the opinions 210 by using belief fusion and belief discounting operators until a resultant value, or consensus, is calculated indicating the overall belief that the event represented in the hypothesis 250 is true or will occur (or alternatively, is false or will not occur). The system can accommodate opinions 210 produced by analysts 410 and those produced by characterizers 420. Characterizers 420 are independent software agents capable of generating opinions 210 in specific topic domains 400 and can be queried for information during the process of analyzing evidence items 230. Characterizers 420 are connected to one or more knowledge bases 430, which contain collections of rules and data which assists the characterizers 420 in producing opinions 210. Both analysts 410 and characterizers 240 have access to a shared evidence storage 240 (e.g., a database), which may also be referred to as the “evidence cloud.”

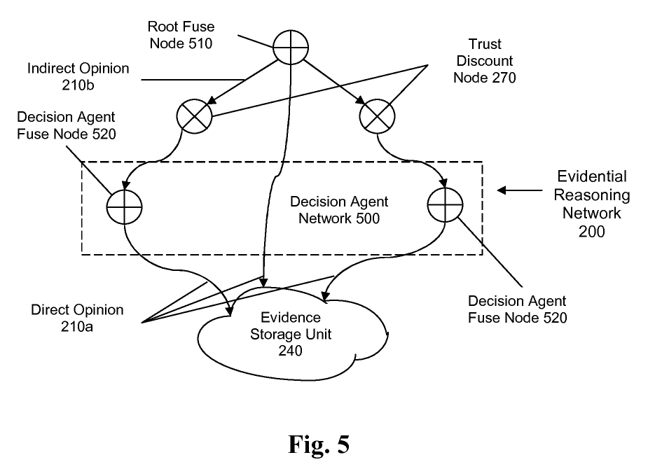

FIG. 5 shows the relationship among direct opinions 210a, indirect opinions 210b, and a decision agent network according to an embodiment of the invention. A root fuse node 510 is the highest level decision agent fuse node 520 in the network, such that its opinions are not used by other decision agents in the network. The root fuse node 510 is connected to the rest of the network via direct opinions 210a, which are opinions on evidence items 230 in the evidence storage unit 240, or via indirect opinions 210b, which are opinions on decision agent fuse nodes 520. A decision agent fuse node 520 (i.e. subordinate fuse node) is a node in the evidential reasoning network 200 grouped in a decision agent network 500 that may include both analysts 410 and characterizers 420 producing opinions by considering the evidence items 230 stored in the evidence storage unit 240. Direct opinions 210a and indirect opinions 210b are placed in the system by the root fuse node 510 either manually or automatically based on domain-dependent assumptions. For instance, in some embodiments of the invention, it may be the case that a specific domain only operates on information gathered from textual sources, and as such, the system can automatically create agents for that textual domain. The root fuse node 510 can then fine-tune the “weight” of the opinions expressed by other analysts in the network by modifying the trust opinions on those other participants stored in the trust discount nodes 270. Decision agents 260 create direct opinions 210a which are subjective statements made about the quality and content of the information with respect to the current hypothesis, while the root fuse node 510 creates indirect opinions 210b which are statements regarding the trust the root fuse node 510 has in the quality of the decision agent's analytical skills and opinions in the given topic domain.

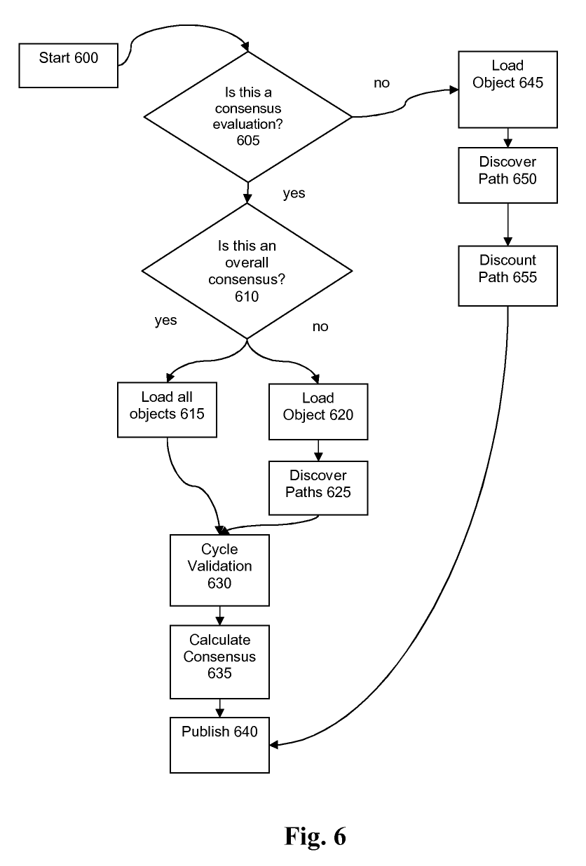

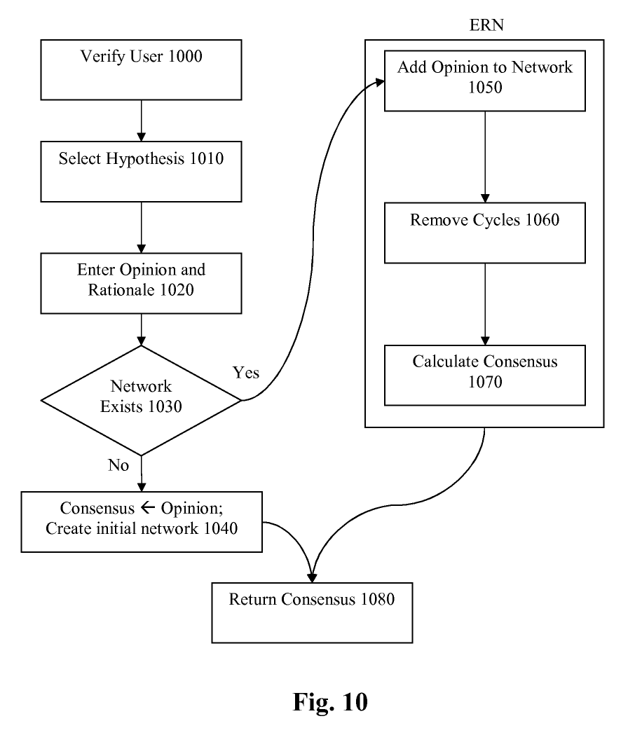

The flow diagrams in FIGS. 6 and 10 illustrate the steps involved in querying the system, which accepts the following three general questions:
1. What is the overall consensus for hypothesis X?
2. What is the consensus for hypothesis X on intelligence item Y?
3. What is the value of decision agent Z's opinion in the network on hypothesis X?

FIG. 6 is a flow diagram illustrating how the system answers these three questions. Decision point 605 (“Is this a consensus evaluation?”) determines if the question is a consensus operator or a simple value query from an opinion source (i.e., a decision agent) to an object (i.e., an evidence item or another decision agent). If the query is requesting a consensus result, the request is forwarded to another decision point, decision point 610. Decision point 610 (“Is this an overall consensus?”) determines if the method should use all objects within the hypothesis or a specific object. If the query is an overall consensus query, the “load all objects” procedure 615 loads every object within the hypothesis that is connected to the rest of the network. With all objects loaded, the “cycle validation” procedure 630 removes any cycles that exist among all loaded objects by removing the opinions with the least level of impact on the system. With the resultant directed acyclic network, the “calculate consensus” procedure 635 computes the overall consensus value for the collection of paths that form the acyclic network.

If the query requested is not for an overall consensus, the “load object” procedure 620 loads a single object in the system. The method will then identify all the connection points to that object by discovering paths 625, taking a single starting point and end point and finds all paths connecting the two points. The resultant collection of paths is sent through cycle validation 630 and consensus calculation 635 before the publication 640 of the results occurs.

Lastly, if the query is not a consensus query, the system will load an object 645 and then load the path between the opinion source (object) and opinion consumer (subject) in the “discover path” block 650. The “discount path” procedure 655 modifies the opinion by assessing the impact of trust on the opinion path. This discounted opinion is then published 640 to the user.

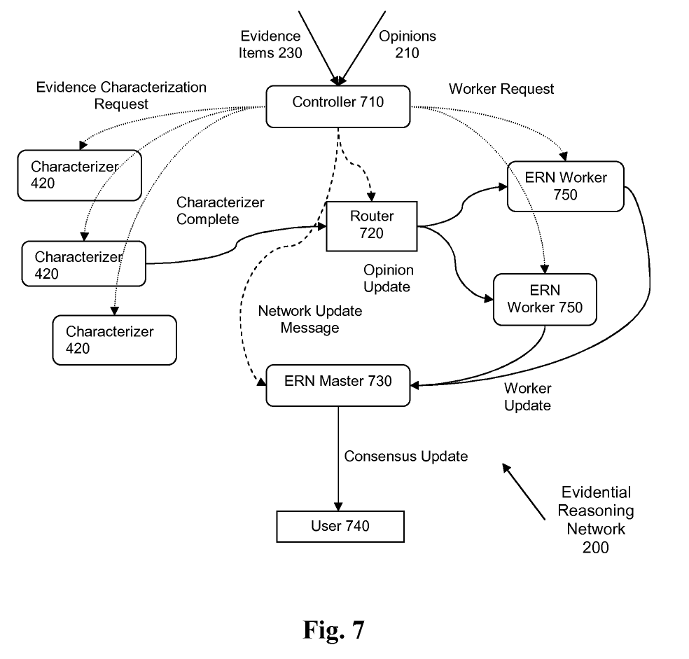

In the one embodiment, the system may be a large-scale evidential reasoning network with a large number of hypotheses and decision agents, and the system may function in a distributed fashion. In such an embodiment, the system processing is broken into parts, allowing sections to be executed concurrently. The various parts of the evidential reasoning network may run simultaneously on multiple central processing units (CPUs), which may exist on a single machine or multiple machines via a network connection. As shown in FIG. 7, the primary execution is controlled by the controller 710, which operates as a service capable of accepting opinions 210. In one embodiment, the opinions 210 are represented as JavaScript Object Notation (JSON) or eXtensible Markup Language (XML) objects. The controller 710 can also accept evidence items 230. In one embodiment, the evidence items 230 may be Uniform Resource Identifiers (URIs), strings of characters used to identify a resources on the Internet. In one embodiment, the evidential reasoning network's components communicate over HyperText Transfer Protocol (HTTP), allowing hardware and network setups to be used.

The distributed version of the evidential reasoning network depicted in FIG. 7 contains three coordinating components (described below) which are responsible for load balancing, configuration, and ensuring that the computation of the various networks is done in an assured manner. The evidential reasoning network is capable of running two types of jobs in parallel: characterizers 420 and ERN workers 750. First, the characterizers 420 are managed by the controller and are capable of being run on different machines and contributing towards different hypotheses. The second type of job is the ERN worker 750, which maintains a portion of the overall evidential reasoning network and performs the computations required by the ERN master 730, which is a delegator and manager for ERN computations. In one embodiment, these computations and resulting opinions are may be transmitted via JSON or XML.

As mentioned above, there are three specialized components within the large-scale evidential reasoning network:
(1) The controller 710, which is responsible for load balancing (i.e., ensuring that no machine is overloaded with processing tasks) and the initial configuration, routing, and startup of the characterizers 420 and ERN workers 750.
(2) The router 720, which handles completed outputs of characterizers 420, and maintains a registry of ERN workers 750. When a “characterizer complete” message is received, the router 720 forwards the message to the appropriate ERN worker 750, providing a decoupling from the characterizers 420 and the evidential reasoning network 200.
(3) The ERN master 730, which contains the functionality to aggregate the different ERN workers 750, and is responsible for the computation of multiple hypotheses functions at the same time.

In one embodiment, the controller 710 has the option of placing characterizers 420 and ERN workers 750 on the same machine and will do so if they are commonly assigned to the same hypothesis 250. The controller 710 monitors the usage levels of the different hypotheses 250, and if one is being used in an increasing fashion but is distributed over a large number of machines, the controller 710 will attempt to reduce the number of machines invoked while ensuring that the individual machines are load balanced. In this fashion, the distributed system ensures that large scale hypotheses are load balanced with priority over seldom used hypotheses.

Additionally, the controller 710 can spawn new characterizer 420 or ERN worker 750 services and, when doing so, updates the router 720 and ERN master 730 with the changes in the underlying network.

The router 720 maintains a registry of available ERN workers 750 and the hypotheses they are working on, and as such, must be notified of changes the controller 710 makes to the underlying network. Therefore, when the controller 710 makes changes to the network, a notification message is sent to the router 720. It is possible that the router 720 may have stale information. If this is the case, when a new message is received, the router 720 can detect changes in its registry and send out a cancellation message to the ERN workers 750.

The ERN master 730 is aware of how many ERN workers 750 are assigned to work towards a given hypothesis and receives periodic updates from the controller 710. ERN workers 750 are required to send periodic status messages to the ERN master 730. In one embodiment, these messages may be JSON or XML transmissions containing the network state of the ERN worker 750. This allows the ERN master 730 to update its values for the overall consensus of the hypothesis 250.

Use of the Evidential Reasoning System in Intelligence Analysis

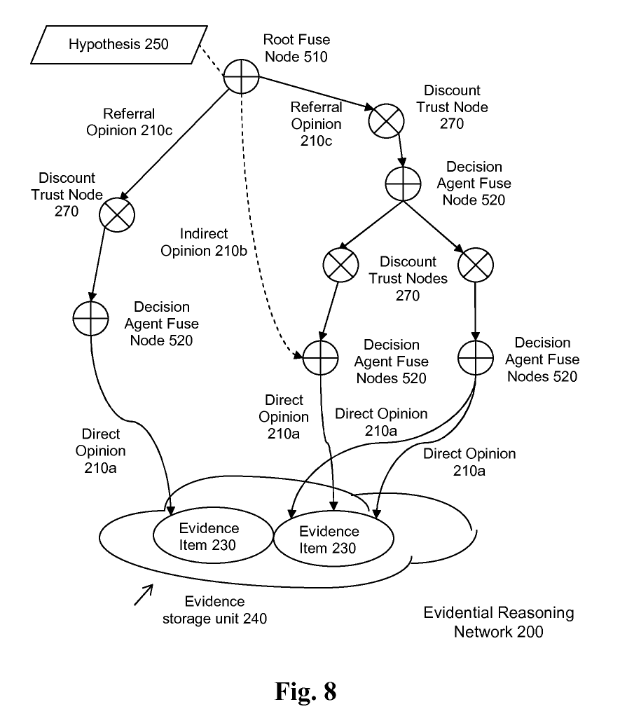

FIG. 8 depicts an embodiment of the system that may be used in intelligence analysis and other fields. Viewing the system from a bottom-up approach, evidence items 230 are collected from the evidence storage unit 240, which contains information from many—possibly disparate—data sources. The data sources may be search engines containing data from open and closed sources of information. Evidence items 230 are available for analysis conducted by decision agents (i.e., analysts or characterizers), which can create direct opinions 210a, which are opinion objects that are a direct evaluation of the quality of the information with respect to the hypothesis 250. In one embodiment, opinions may be represented via Extensible Markup Language (XML) or JavaScript Object Notation (JSON), allowing systems to share data in a service-oriented fashion.

When a decision agent creates a direct opinion 210a, a second decision agent may “join” the evidential reasoning network 200 by creating a referral opinion 210c on the source of the direct opinion 210a. The referral opinion 210c may be created by one of two means, depending on the type of the decision agent 260 involved. In the case of an analyst, the referral opinion 210c is created by a user interface control that permits the setting of the (Belief, Uncertainty, Disbelief) tuple, selecting the hypothesis 250, and selecting the opinion source, i.e. the decision agent 260 whose opinion the analyst 410 is evaluating. In the case of a characterizer 420, the characterizers 420 use their domain knowledge to produce opinions 210 on evidence items 230 within the evidence storage 240. In one embodiment, the characterizers submit XML- or JSON-formatted opinion to the evidential reasoning network 200.

When a referral opinion 210c is received within the evidential reasoning network, the system dynamically creates the edges and nodes necessary based on the opinion's subject and objects. In the case of a referral opinion 210c, an indirect opinion 210b is created if there is a path from the source to the target that contains a mixture of referral opinions 210c and direct opinions 210a.

After the opinion 210 is added to the network, two operations are available. The first is the calculation of the indirect opinion 210b. Referring to FIG. 8, in one embodiment an decision agent (see decision agent fuse node 520) may create a referral opinion 210c on another decision agent (see decision agent fuse node 520), who already has a direct opinion 210a on evidence item 230. After adding that opinion to the network, a path exists such that the root fuse node 510 has an indirect opinion 210b on evidence 230, which routes through the analyst fuse node 510 and decision agent fuse node 520. The resulting indirect opinion 210b is calculated by the following equation:

ω₅₁₀²³⁰=ω₅₁₀²⁶⁰ [symbol] ^{ω}₂₆₀⁵²⁰ [symbol] ω₅₂₀²³⁰

The indirect opinion 210b that the root fuse node 510 has on evidence item 230 is formulated based on the underlying network on which the root fuse node 510 has referral opinions 210c.

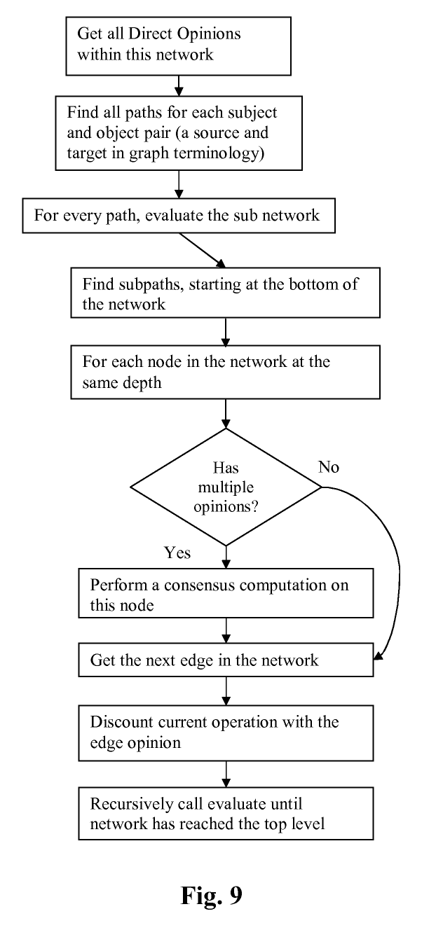

The second operation available is the computation of the holistic view of hypothesis 250. In this case, the entire network that the root fuse node 510 is connected to is used in the calculation of a final consensus value. The general algorithm used by the Evidential reasoning system to calculate this consensus is shown in FIG. 9.

Referring back to FIG. 8, FIG. 9 results in the following computation being performed, where:

⊕=a consensus operation using a probabilistic calculus

[symbol] =a discount operation using a probabilistic calculus

The consensus opinion that the root fuse node 510 has in hypothesis 250 can be represented as:

ω₅₁₀²⁵⁰=(ω₅₁₀²¹⁰ [symbol] ^{ω}₅₂₀²³⁰)⊕ω₅₁₀⁵²⁰ [symbol] ^{((ω}₅₂₀⁵²⁰ [symbol] ω₅₂₀²³⁰)⊕(ω₅₂₀⁵²⁰ [symbol] ω₅₂₀²³⁰⁾⁾

In one embodiment, this method of using the system can be described through illustration of use, whereby a group of intelligence analysts are assigned to work on a case with one or more hypotheses (or a question) that needs to be analyzed. Consider the hypothesis described in the earlier example: “Is Dave a good mechanic?” Because this is a multi-user environment, each participating analyst (user) is first authenticated with a user identifier and a password. The system may use this unique user information to identify the source of analyst opinions in order to create the appropriate ERN structure where opinions are linked to decision agents.

FIG. 10 depicts the system information flow in which analysts add opinions to the network. In step 1000, the analyst authenticates his or her identity. Because the system may have many hypotheses being analyzed concurrently, the analyst must select a hypothesis to serve as the basis for an opinion in step 1010. If no hypotheses exist from which to choose, the user may create a new hypothesis.

In one embodiment, an opinion may have many important components, which are necessary for proper function of the network. First, in any embodiment of the invention, a Belief tuple (consisting of Belief, Uncertainty, and Disbelief values) is required and is the numeric quantification of the belief In a preferred embodiment, a rationale for the opinion is optionally provided by the user in order to explain the reasoning behind the opinion. Implicit in the newly created opinion is the scope, which is the current hypothesis, or, in this example, “Is Dave a good mechanic?” Finally, the opinion requires a subject (i.e. the analyst who created the opinion) and an object (i.e., the evidence item about which the opinion is offered). The addition of an opinion in the system 1050 requires these components (some being optional) for the network to function properly.

In step 1030, the system determines if a trust network already exists by first checking if the opinion's belief frame exists, and then checking if the subject and object of the opinion exist within the ERN network representation. If the trust network does exist, the new opinion is added to a network in step 1050. As the potential to create a cyclical network exists at this point (where subject and object both have opinions on each other), cycles are removed from the network in step 1060 just after opinions are added. In one embodiment of the invention, this is done by creating a set of directed series parallel graphs (DSPG). DSPGs may be represented as graphs with two terminal nodes, with a cycle-free sub-graph between them, and the evidential reasoning network can be viewed as combinations of DSPG's. The evidential reasoning network then calculates (or recalculates) the consensus of the hypothesis in step 1070 by using a bottom-up evaluation procedure, as previously described in FIG. 8. If the opinion network does not exist, it is created by the evidential reasoning network and the opinion is inserted into the opinion network in a single step process. This root consensus node is returned immediately 1080, while other individual nodes can be later queried by the user.

In our initial example depicted in FIG. 1, the consensus over the trust network represents Jim's overall opinion on whether or not Dave 140 is a good mechanic. Jim's consensus node is the root consensus node of the network in this case.

In one embodiment of the invention, analysts work on cases, or requests for information. Within a case, users can create multiple hypotheses using the system of the present invention. A lead analyst is assigned to each hypothesis, which has the final decision in the outcome of the hypothesis. The lead analyst is responsible for adding other decision agents that are capable of producing opinions about the hypothesis of interest.

In this embodiment, all analysts working on a hypothesis have the ability to attach their opinions to any evidence object within the evidence store, where an evidence item can be a specific entity of interest (e.g., a person, place, or event), an existing annotation, or another intelligence item (e.g., a document or a conversation). The system creates a trust network where all opinions are potential contributors to the overall value of the hypothesis and can derive the overall consensus value according to the method described above.

This embodiment uses the evidential reasoning network in such a fashion that multiple hypotheses are kept logically distinct; however, in another embodiment, a hierarchy can be created where one or more hypotheses contribute to a larger hypothesis, thus forming a hierarchical system for the evaluation of multiple related hypotheses.

This embodiment also allows the user to access subsections of the overall evidential reasoning network. Consensus values can be derived based on individual items of intelligence or evidence objects within the system. For instance, using our previous example, a query may ask, “What is the opinion of Bob about Dave being a good mechanic?” In this case, the system will return Bob's direct opinion on the hypothesis “Dave is a good mechanic.” The system can also be queried for individual paths of trust. Referring to the same example, Jim 100 can query the path of trust leading from him to Steve 120 and then to Dave being a good mechanic 150.

A Method for Use of the Evidential Reasoning System in Information Fusion and Federated Search

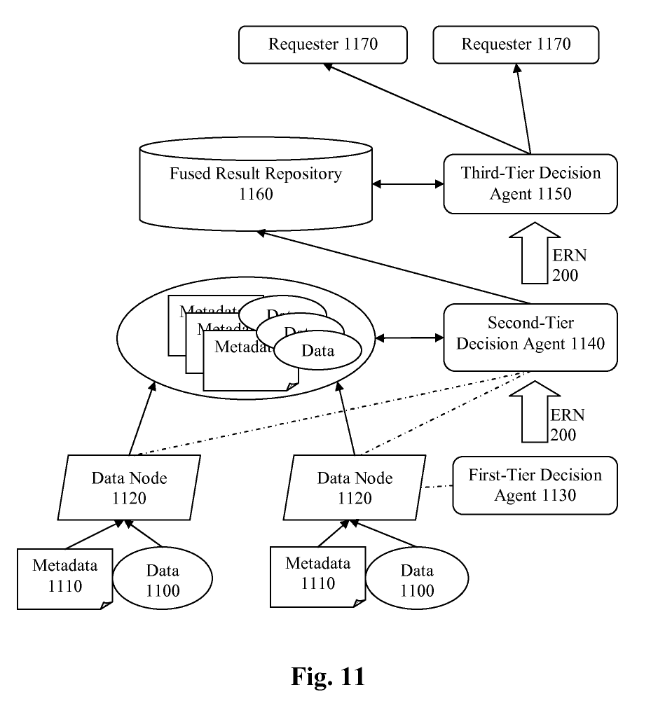

FIG. 11 depicts an embodiment of the system that can be used in information fusion and related fields. Specifically, this embodiment is aimed at problems in which multiple, potentially related data elements must be analyzed and correlated against each other by a set of decision agents. This embodiment is not concerned with the specific inner workings or logic of how these decision agents rate or analyze the data elements; however, it provides the framework through the evidential reasoning network for combining the decision agents' opinions into a coherent, repeatable and well-documented hierarchical fusion.

This approach employs multiple autonomous software agents who analyze the available data and can create opinions on that data with respect to a common goal or hypothesis. The agents are classified into different tiers reflecting their scope of analysis and action. In FIG. 11, first-tier decision agents 1130 are low-level decision agents that analyze raw data at the level of the data node 1120 and each first-tier decision agent operates on one data node only. The results of the first-tier analysis, which are in the form of decision agent opinions, are then attached to the data node 1120 as a metadata element 1110 for each data element 1100. Those decision agent opinions are also inserted in a common ERN 200. Second-tier decision agents 1140 inspect the metadata elements 1110 and perform a cross-node analysis and correlation, and thus operate on multiple data nodes at a time. The results of the second-tier cross-node analysis are posted to a fused results repository 1160. The third-tier decision agents 1150 are responsible for reading the results deposited by the second-tier decision agents 1140 from the common repository, making decisions as to the applicability of results to various requestors 1170 and posting those applicable results to the requesting party 1170. The functional glue that ties all levels together is the evidential reasoning network described earlier. All decision agents in the three tiers use the ERN mechanism of applying opinions to the data with respect to the applicability of the data or higher-level fused results (metadata) to a specific requestor's query.

In one embodiment, this method may be used in the field of information retrieval, specifically, in applications where the results of searches across multiple information sources are fused together to provide a single federated search. The present invention provides the framework and system, through ERN, as well as the method, described further below, to merge the results from multiple traditional search engines into one, coherent, ordered result set according to the analyst's query.

Both traditional search engines (i.e., those that search a single document source) and federated search engines (i.e., those that combine the results of multiple traditional search engines) typically utilize keyword searches to retrieve documents from a pre-built index of all documents. Federated search engines typically receive the keyword-based query and forward it to one or more traditional search engines. After receiving results from the traditional search engines, the federated search merges those results.

There are various approaches to calculating a match between the search query and a document in the traditional search engine index. For instance, the term-vector space model creates vectors of terms (i.e., words or phrases) for the query and all documents and determines the vector angle between the search vector and any document vector. A vector angle of 1 indicates total overlap, meaning that the entire query is located within the document. A vector angle of 0 indicates no overlap, meaning that no query terms are present in the document.

Another approach, called the probabilistic relevance model, uses a retrieval function that ranks a set of documents in the search engine's repository based on the number and frequency of query terms appearing in each document. However, in that model, the mathematical scoring function used is different, using Bayes' theorem to compute probabilities given observations.

As these various approaches to traditional searching have their individual advantages and disadvantages, a federated search engine that combines the results from these various scoring systems is a valuable tool for information retrieval. Among other things, the present invention provides a method for implementing a federated search engine using an ERN-based trust network of opinions to produce one final aggregate scoring for the ranking of the result sets from multiple search engines, relative to a single search query. Some of the advantages of this method include that: (a) it is applicable to a wide variety of underlying traditional search engines being federated; (b) it provides a natural method for federating results by applying a common framework for comparison and correlation of the search results from disparate sources; (c) it is powerful in representation, as the ERN opinions can represent belief, disbelief and uncertainty in the result set elements being relevant (as opposed to a single percent match value to the query).

The central theme of this approach is the application of simple, limited-focus agents in a multi-level hierarchy for information fusion, along with the opinion fusion functions in the ERN for maintaining relevancy and certainty pedigree of the fused data. Decision agents that produce fusion opinion metadata about the baseline data items also insert those opinions in a corresponding ERN structure for hierarchical fusion. Each new piece of metadata generated by a decision agent, whether related to the data content or to the data quality, is tagged with the decision agent's opinion of the fitness of the corresponding data item to the overally query. Opinions issued by agents may be formed by a consensus combination of the decision agent's own opinion with the provided opinions of other decision agents from lower tiers, or other metadata opinions that came with the original data. Additionally, when multiple agents provide support for (or dissent against) a particular data item or metadata item, consensus operations can be performed to provide a unified opinion for that item.

The system specifically consists of three tiers of agents performing unique roles in data and meta-data analysis using the system of the present invention for belief fusion and data quality management.

First-Tier Decision Agents

The decision agents categorized into the first tier are those which analyze raw data (e.g., data directly received from sensors, other systems, or humans) to derive further information and metadata. Quite simply, these can be considered “input” decision agents. Incoming data can be filtered or classified for consumption at the next layer. These operations are usually performed on a single data node; however it is possible that groups of nodes can be operated on at this level with the limitation that they must be static groups. For example, a decision agent may examine groups of measurements from a single sensor (or sensors of similar type) to correct for a bias in the sensor(s). In order to avoid cycles in processing, groups proposed by the system (as well as anything produced by the system) are off-limits.

This layer is also responsible for generating the first real sets of ERN opinions about data. Some incoming data may already come with opinions expressing the reliability or accuracy of a data source. However, this is not a requirement at all, so that the sources of data may include, for example, any digital sensor or data provider connected to the system. This first tier of decision agents produces the first data elements that can be counted upon to have an attached opinion metadata.

Once new data has been processed by agents in this tier, the second tier is allowed to begin processing. In a preferred embodiment, data elements may be staggered, or pipelined, through the first tier of decision agents, so that the second tier of decision agents can start processing immediately after the first data elements are processed by the first tier decision agents.

Second-Tier Decision Agents

The second-tier decision agents exist to process generated data and discover commonality between groups of nodes. Simply put, this is the “processing” layer. It takes in metadata (tagged with opinions) and creates more, related metadata (possibly applying to a group of nodes or a group of data elements). It is also possible that a decision agent of this tier may make use of the original data just as a first-tier decision agent; this is considered a hybrid approach but the hybrid still operates in the second-tier phase of processing. The output of second-tier decision agents consists of two items: (1) a group of nodes and (2) the set of labels, values and opinions to apply to that group.

In one embodiment, there is recursive processing in the second-tier phase. Groups and metadata generated by one second-tier decision agent may be used by other second-tier decision agents. These can then produce new data or alter opinions such that the first decision agent must recalculate its own output. This is an ongoing process of refinement between the arrivals of data elements from outside the system. However, during this continuous refinement process, there always exists a most current set of labels that describes the fusion of the existing data up to that point; the processing of any data set can always be interrupted and forced to the third stage if fusion, processing, or timing/resource constraints are met. While refinement may or may not continue in the second layer, the third layer of agents examines the current state of knowledge for situations that must be reported to a human user or the requesting higher system.

Third-Tier Decision Agents

The final layer of decision agents tracks situations of interest for the user (or higher requesting system) and provides reports and alerts when appropriate. This means that the third tier of agents serves as the “output” layer. This is also the only layer intended for direct human interaction. Normally, each fusion or analysis process would require tuning by the user to achieve favorable results. Due to the tagged belief that accompanies every piece of data, only the final layer must be concerned with tuning. From the severity of the monitored situation, the user determines what level of belief is acceptable. As data of poor quality will cause lower final belief values, this setting effectively tunes the whole system because poor quality metadata will go unused when better options are available.

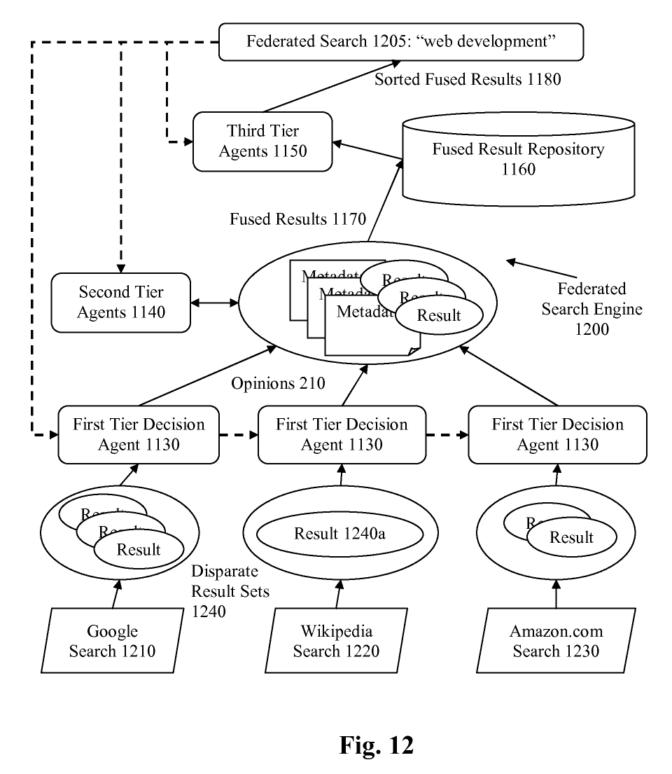

FIG. 12 depicts a simple federated search 1205 that brings together results from three traditional search engines: Google search 1210, Wikipedia search 1220, and Amazon.com search 1230. User enters a keyword search string, for example “web development”, into the federated search engine 1200.

The federated search engine 1200 sets up an initial ERN with a first tier 1130, a second tier 1140, and a third tier 1150. The decision agents in these three levels provide ERN opinions on each of the result sets. The federated search 1205 issues the search query to each of the three traditional search engines, Google 1210, Wikipedia 1220, and Amazon.com 1230. First-tier decision agents 1130 process the results from each traditional search engine, one first-tier decision agent 1130 per search engine. Each first-tier decision agent 1130 produces an ERN opinion on each result entry in its search engine's result set 1240. The opinion is a depiction of the decision agent's confidence that the result entry matches the original requester's query, “web development”. Each decision agent 1130 issues its opinions based on its internal rules and its knowledge of the corresponding traditional search engine and its result set structure. This step produces standard ERN opinions regarding the fitness of any particular result entry 1240a; those standard opinions can be compared across the results from all traditional search engines. The opinions 210 are attached to each result entry's metadata and the structure is forwarded to the second tier of agents within the ERN structure of the federated search engine 1200.

The second-tier decision agents 1140 work with all search results with corresponding opinions attached to them, discovering and resolving any overlaps, conflicts and inconsistencies. They issue their second-tier opinions on each of the results in the now-joint result set. The process of continual refinement may be repeated until certain conditions of accuracy, confidence (lack of uncertainty in the opinions), or time limits are met. At that point the stream of fused opinion-tagged results is forwarded to the third tier of decision agents 1150.

The third-tier decision agents 1150 perform the ERN consensus operator for each result item across the trust chain leading from the original search engine, to the first-tier decision agents' opinions 210 to the second-tier decision agents' opinions. The consensus value on each item is the final score that the third-tier decision agents use to sort the result set 1180 before providing it to the federated search user.

Note that search result entries stored in the Fused Results Repository 1160 can be reused for new queries that overlap with some pre-existing queries. For example, an item that was a good match for “web development” would likely be a good match for “software programming,” based on the close semantic relationship between the two queries.

What is claimed:

1. An evidential reasoning system comprising:
a root fuse node;
at least one decision agent having a subordinate fuse node; and
one or more evidence items;
wherein said at least one decision agent renders at least one direct opinion on said one or more evidence items; and
wherein said root fuse node is coupled to said subordinate fuse node through a trust discount node.

2. The system of claim 1, wherein said at least one decision agent is a human analyst.

3. The system of claim 1, wherein said at least one decision agent is a characterizer.

4. The system of claim 3, wherein said characterizer accesses one or more knowledge bases.

5. The system of claim 1, wherein said direct opinion is expressed with respect to a hypothesis.

6. The system of claim 1, wherein said one or more evidence items are stored in an evidence storage unit.

7. The system of claim 1, wherein said subordinate fuse node is represented by an evidential reasoning opinion.

8. The system of claim 7, wherein said evidential reasoning opinion is expressed in terms of at least belief and uncertainty values.

9. The system of claim 8, wherein said evidential reasoning opinion comprises a subject and an object.

10. The system of claim 8, wherein said evidential reasoning opinion comprises belief, disbelief, and uncertainty values whose sum equals 1.

11. The system of claim 1, wherein said trust discount node is represented by an evidential reasoning opinion.

12. The system of claim 11, wherein said evidential reasoning opinion is expressed in terms of at least belief and uncertainty values.

13. The system of claim 11, wherein said evidential reasoning opinion comprises a subject and an object.

14. The system of claim 12, wherein said evidential reasoning opinion comprises belief, disbelief, and uncertainty values whose sum equals 1.

15. The system of claim 1, wherein an indirect opinion is generated by performing a belief algebra discount operator on said subordinate fuse nodes and said trust discount node.

16. The system of claim 15, wherein said belief algebra discount operator is a subjective logic discount operator.

17. The system of claim 16, wherein said subjective logic discount operator is described by the following equations:
bₓ^{A,B}=b_{B}^{A}bₓ^{B}
dₓ^{A,B}=b_{B}^{A}dₓ^{B}
uₓ^{A,B}=d_{B}^{A}+u_{B}^{A}+b_{B}^{A}uₓ^{B}
wherein opinion ω_{B}^{A} is represented by tuple (b_{B}^{A}, d_{B}^{A}, u_{B}^{A}), opinion ωₓ^{B} is represented by tuple (bₓ^{B}, dₓ^{B}, uₓ^{B}) and the resultant opinion ωₓ^{A,B}=(ωₓ^{A} [symbol] ωₓ^{B}) is represented by tuple (bₓ^{A,B}, dₓ^{A,B}, uₓ^{A,B}).

18. The system of claim 1, further comprising one or more external requesters, wherein said one or more external requestors make query requests.

19. The system of claim 1, further comprising at least one data node that produces at least one data item, wherein said at least one decision agent aggregates said at least one data item from said at least one data node to answer said query requests

20. The system of claim 19, wherein said at least one data node represents traditional search engines,
wherein said at least one data item represents search results;
wherein said query requests represent a federated search query,
wherein aggregated query results obtained by using said system represent an aggregated result set of said federated query.

21. An evidential reasoning system comprising:
a root fuse node;
at least one first decision agent having a first subordinate fuse node;
at least one second decision agent having a second subordinate fuse node; and
one or more evidence items;
wherein a fused node opinion is generated by performing a belief algebra consensus operator on said first subordinate fuse node and said second subordinate fuse node.

22. The system of claim 21, wherein said belief algebra consensus operator is a subjective logic consensus operator.

23. The system of claim 22, wherein said subjective logic consensus operator is described by the following equations:
$$K = {u}_{x}^{A} + {u}_{x}^{B} - {u}_{x}^{a} {u}_{x}^{B}$$
$${b}_{x}^{A , B} = \frac{{b}_{x}^{A} {u}_{x}^{B} + {b}_{x}^{B} {u}_{x}^{A}}{K}$$
$${d}_{x}^{A , B} = \frac{{d}_{x}^{A} {u}_{x}^{B} + {d}_{x}^{B} {u}_{x}^{A}}{K}$$
$${u}_{x}^{A , B} = \frac{{u}_{x}^{A} {u}_{x}^{B}}{K}$$
wherein opinion ωₓ^{A} is represented by tuple (bₓ^{A}, dₓ^{A}, uₓ^{A}), opinion ωₓ^{B} is represented by tuple (bₓ^{B}, dₓ^{B}, uₓ^{B}) and the resultant opinion ωₓ^{A,B}=(ω_{B}^{A}⊕ωₓ^{B}) is represented by tuple (bₓ^{A,B}, dₓ^{A,B}, uₓ^{A,B}).

24. An evidential reasoning system comprising:
a root fuse node;
at least one first decision agent having a first subordinate fuse node;
at least one second decision agent having a second subordinate fuse node; and
one or more evidence items;
wherein said at least one second decision agent renders at least one direct opinion on said one or more evidence items;
wherein said at least one first decision agent renders a referral opinion on said at least one second decision agent; and
wherein said root fuse node is coupled to said second subordinate fuse node through said referral opinion.

25. The system of claim 24, wherein said root fuse node is coupled to said one or more evidence items through at least one direct opinion.

26. The system of claim 24, wherein said referral opinion passes through a trust discount node.

27. The system of claim 24, wherein said at least one decision agent is a lead analyst.

28. The system of claim 27, wherein said lead analyst manages a hypothesis.

29. A method for analyzing evidence comprising:
(i) receiving at least one direct opinion produced by at least one decision agent; and
(ii) rendering at least one referral opinion on said at least one direct opinion;

30. The method of claim 29, further comprising producing at least one indirect opinion based on said at least one direct opinion and said at least one referral opinion.

31. The method of claim 29, where said indirect opinion is derived from a evidential reasoning system comprising:
a root fuse node;
at least one first decision agent having a first subordinate fuse node;
at least one second decision agent having a second subordinate fuse node; and
one or more evidence items;
wherein a fused node opinion is generated by performing a belief algebra consensus operator on said first subordinate fuse node and said second subordinate fuse node.

32. The method of claim 29, where fused opinions at fuse nodes of the evidential reasoning network are derived from an evidential reasoning system comprising:
a root fuse node;
at least one first decision agent having a first subordinate fuse node;
at least one second decision agent having a second subordinate fuse node; and
one or more evidence items;
wherein a fused node opinion is generated by performing a belief algebra consensus operator on said first subordinate fuse node and said second subordinate fuse node.

33. The method of claim 29, where at least one hypothesis is analyzed using an evidential reasoning system comprising:
a root fuse node;
at least one first decision agent having a first subordinate fuse node;
at least one second decision agent having a second subordinate fuse node; and
one or more evidence items;
wherein a fused node opinion is generated by performing a belief algebra consensus operator on said first subordinate fuse node and said second subordinate fuse node and using evidence items entered in said system.

34. The method of claim 29, wherein said direct opinion is represented by an evidential reasoning opinion.

35. The method of claim 34, wherein said evidential reasoning opinion is expressed in terms of at least belief and uncertainty values.

36. The method of claim 34, wherein said evidential reasoning opinion comprises a subject and an object.

37. The method of claim 35, wherein said evidential reasoning opinion comprises belief, disbelief, and uncertainty values whose sum equals 1.

38. A computer-readable medium having computer-executable instructions stored thereon for performing a method for analyzing evidence, said method comprising:
(i) receiving at least one direct opinion produced by at least one decision agent; and
(ii) rendering at least one referral opinion on said at least one direct opinion.

39. The computer-readable medium of claim 38, further comprising the step of producing at least one indirect opinion based on said at least one direct opinion and said at least one referral opinion.
